(19) United States
(12) Patent Application Publication
(10) Pub. No.: US 2012/0197979 A1
(43) Pub. Date: Aug. 2, 2012

(54) WEB-WIDE CONTENT QUALITY CROWD SOURCING

(76) Inventors: Leon G. Palm, Santa Monica, CA (US); Doug Coker, San Francisco, CA (US); Colby D. Ranger, San Francisco, CA (US); Daniel J. Berlin, North Potomac, MD (US); Helen V. Hunt, Washington, DC (US); Ethan C. Ambabo, Evanston, IL (US); John D. Westbrook, Reston, VA (US)

(21) Appl. No.: 13/356,138

(22) Filed: Jan. 23, 2012

Related U.S. Application Data
(60) Provisional application No. 61/435,682, filed on Jan. 24, 2011.

(51) Int. Cl. G06F 15/16

(52) U.S. Cl. 709/203

(57) ABSTRACT

Method, computer-readable media, and systems for centralizing votes submitted for content items hosted on multiple distinct and uncoordinated content sources, and ranking the content items against one another across the multiple distinct and uncoordinated content sources based on the centralized votes are disclosed. Recommendations of content items hosted by an original content source can be provided to users on the content interfaces of other content sources and additional votes for the recommended content items can be collected through the voting controls accompanying the recommend content items on the content interfaces of these other content sources.

### CROSS-REFERENCE TO RELATED APPLICATIONS

Under 35 U.S.C. §119, this application claims benefit of pending U.S. Provisional Application Ser. No. 61/435,682, filed Jan. 24, 2011, the entire contents of which are hereby incorporated by reference.

### BACKGROUND

This specification relates generally to ranking content.

The Internet provides access to a great number of forums in which people can exchange information, ideas, opinions, and digital resources of various formats. Examples of online forums include websites, blogs, digital bulletin boards, online discussion boards, social networking sites, online gaming sites, online marketplaces, and so on. A user of an online forum can submit content items (e.g., information, questions, ideas, comments, images, videos, electronic books, music files, and/or media resources) to a host of the online forum, and the host then provides the submitted content item, and optionally, additional content items, to other users for viewing and/or comments.

The host of an online forum can rank the content items published in the online forum based on the user feedback received for each content item. The feedback for a content item can be in the form of respective votes (e.g., either favorable or unfavorable votes) provided by the forum users who have viewed the content item in the online forum.

### SUMMARY

This specification describes technologies relating to ranking and providing content online.

In general, one aspect of the subject matter described in this specification can be embodied in a method that includes the actions of: receiving, at a centralizing server, from a first plurality of user devices respective first votes for a first content item, the first content item being hosted by a first content source and provided to each of the first plurality of user devices with a respective first voting control on a respective first content user interface; receiving, at the centralizing server, from a second plurality of user devices respective second votes for a second content item, the second content item being hosted by a second content source distinct from the first content source, and provided to each of the second plurality of user devices with a respective second voting control on a respective second content user interface, wherein each of the first voting controls and the second voting controls is configured to transmit a respective vote received on a respective user device to the centralizing server; calculating a first score for the first content item based at least in part on the first votes, and a second score for the second content item based at least in part on the second votes; and ranking the first content item hosted by the first content source and the second content item hosted by the second, distinct content source, based at least in part on the first score of the first content item and the second score of the second content item.

Other embodiments of this aspect include corresponding systems, apparatus, and computer programs, configured to perform the actions of the methods, encoded on computer storage devices.

These and other embodiments can optionally include one or more of the following features.

In some implementations, the first votes include at least a positive vote and at least a negative vote for the first content item, and wherein the first score is based on a first statistical confidence interval of the first votes and the second score is based on a second statistical confidence interval of the second votes.

In some implementations, the first content source and the second content source are two distinct websites, and the first content user interface and the second user interface are respective one or more webpages of the two distinct websites, respectively.

In some implementations, data for generating the first content user interface is provided to each of the first plurality of client devices with an accompanying script, and the accompanying script is configured to generate the respective first voting control when executed on the client device.

In some implementations, the centralizing server can further perform the actions of: providing the first content item as a recommended content item to each of a third plurality of user devices with a respective third voting control on a respective third content user interface; receiving respective one or more third votes for the first content item from one or more of the third plurality of user devices through one or more of the respective third voting controls; and calculating the first score for the first content item based on at least the first votes and the respective one or more third votes.

In some implementations, the centralizing server can further perform the actions of: receiving a vote count request for the first content item from a user device, the vote count request having been generated by a script that had been embedded in a respective content user interface provided to the user device; and in response to the vote count request, providing a positive vote count and a negative vote count of the respective first votes. In some implementations, the user device presents the positive vote count and the negative vote count for the first content item within or in proximity to the respective first voting control on the respective content user interface shown on the user device.

In some implementations, the centralizing server can further perform the actions of: providing the first content item to each of a fourth plurality of user devices with a respective voting control on a respective content user interface; and receiving respective one or more votes for the first content item from one or more of the fourth plurality of user devices, where the positive vote count and the negative vote count for the first content item are based on at least the respective votes for the first content item received from the first plurality of user devices and the fourth plurality of user devices.

In some implementations, the centralizing server can further perform the actions of: ranking a plurality of content items for which respective votes have been received from user devices, the plurality of content items including at least the first content item and the second content item, and the ranking being based on at least on respective scores calculated from the respective votes received for the plurality of content items; receiving a content request from a user device, the content request having been generated by a respective script embedded in a respective content user interface shown on the user device; and in response to the content request, providing a plurality of referral elements for presentation on the content user interface, each referral unit referring to a respective one of the plurality of content items whose rank is above a predetermined rank threshold.

Particular embodiments of the subject matter described in this specification can be implemented to realize one or more of the following advantages.

Votes for respective content items hosted by multiple content sources (e.g., websites) are collected using respective voting controls provided with the content items on respective content interfaces (e.g., webpages) and forwarded to a server or collection of servers, where the server or collection of server are coordinated under the same organization entity and collectively serves as a so-called “centralizing server.” The centralizing server ranks the content items hosted by the multiple content sources based on the respective votes collected from user devices that have presented the content items and the voting controls. The multiple content sources can be independent of one another and do not need to coordinate with one another in order to participate in the vote centralization and the ranking process. The centralizing server can provide the ranking of the content items to users (e.g., as a ratings chart). By comparing content items hosted by multiple content sources across the Internet, the centralizing server can give users a broader view of what content items are available on the Internet, and how the content items compare against one another according to a broad range of users.

In some implementations, the centralizing server provides content recommendations to users, where the content recommendations include content items hosted by multiple content sources (e.g., the original content sources). The centralizing server select the recommended items based at least on votes received for the items. The content recommendations can be provided to users through a recommendation interface hosted by the centralizing server or embedded in the content interface of another content source. Respective voting controls are provided with the content recommendations in the recommendation interface, such that votes can be collected for the recommended content items from users who have not visited the original content sources that hosted the recommended content items. Therefore, the content items can be provided to and votes can be collected from a broader range of users, and the confidence level of the ratings generated from the votes can be increased.

In some implementations, a respective user profile can be developed for each user (e.g., each user who has signed up or opted-in for a targeted recommendation service) based on the characteristics of content items that the user has reviewed and the respective votes the user has submitted for those content items. Content recommendations can be provided to the user based the user's profile, such that the content recommendations are more likely to be interesting or relevant to the user.

In some implementations, the voting controls presented with content items can accept both positive votes and negative votes from users, and content items are scored based on statistical confidence intervals of the votes received. The statistical confidence intervals take into account both the number of votes received and the relative numbers of positive votes and negative votes received from the content items. Therefore, the scores calculated based on the statistical confidence intervals are better reflection of users' collective opinions of the content items, making the content ratings more accurate and the content recommendations more relevant.

The details of one or more embodiments of the subject matter described in this specification are set forth in the accompanying drawings and the description below. Other features and advantages of the subject matter will become apparent from the description, the drawings, and the claims.

### BRIEF DESCRIPTION OF THE DRAWINGS

FIG. 1 is an example content interface for providing voting controls with content items.

FIG. 2 is a block diagram of an example online environment in which a centralizing server for web-wide content quality evaluation operates.

FIG. 3 is a flow diagram of an example process for ranking content items hosted by multiple distinct content sources based on user votes.

FIG. 4 is a flow diagram of an example process for providing content recommendations across multiple content sources, and collecting votes on the recommended content items.

FIG. 5 is a flow diagram of an example process for providing a current vote count for a content item with a voting control for the content item on a content interface.

FIG. 6 is a flow diagram of an example process for providing a ranking of content items hosted by multiple content sources based on respective votes received for the content items.

FIG. 7 is a block diagram illustrating an example computer system.

Like reference numbers and designations in the various drawings indicate like elements.

### DETAILED DESCRIPTION

A content source is a host of content items (e.g., images, blog posts, videos, music files, ideas, articles, news items, ads for items on sale, and so on) that can provide the content items to user devices over one or more networks. Examples of a content source include a website, a blog, an online discussion board, an online gaming community, an online marketplace, or other forums where content can be presented to users over the Internet or another network. When requested by a user device, a content source can provide data for generating one or more user interfaces to the user device, where, when rendered on the user device, the user interfaces present one or more content items hosted by the content source. As used in this specification, the user interfaces for presenting the one or more content items hosted by the content source is also referred to as “content interfaces” or “content user interfaces.”

Typically, a content source is under the control of one or more entities. A host of a website or blog, an author of a webpage or blog post, a moderator of an online discussion forum, a host of an online gaming community, or a provider of an online market place, are examples of entities that each controls a respective content source. An entity that controls a content source can decide (e.g., either by directly editing the content interface or by enforcing a content publishing policy or template) what content items to place on its content interface(s), and the structure and appearance of the content interface(s) to users viewing the content interface(s). Examples of content interfaces include webpages, blog posts, application user interfaces for networked applications (e.g., online games, software applications for accessing a social network or online community), and so on.

In some implementations, a content interface includes a respective voting control for each content item presented (e.g., either as an actual digital resource or a referral element linking to the actual digital resource) on the content interface, where a viewer of the content interface can optionally interact with the respective voting control of the content item to submit a vote for the content item. The vote can be either a positive vote to indicate the user's approval of the content item, or a negative vote to indicate the user's disapproval of the content item.

Conventionally, votes may be collected and managed within each content source, for example, by the hosting entity of the content source. As described in this specification, a centralizing server can offer a way for multiple independent and uncoordinated content sources to direct votes on respective content items hosted by the multiple content sources to the centralizing server, such that the content items across the multiple content sources can be ranked against one another based on the respective votes received for the content items by the centralizing server.

In some implementations, the centralizing server makes available a sample script (e.g., a piece of Javascript code) that is configured to generate a voting control (e.g., in the form of a network widget) for a specified content item in a content interface, where the voting control is an interactive user interface element that is configured to accept a user's voting input and forward the vote represented by the voting input to a designated address of the centralizing server. In some implementations, part of the script can refer to another script that is downloadable at runtime from the centralizing server or another designated server to generate the voting control.

An author of a content interface can adapt the sample script for one or more content items on the content interface and embed the adapted script(s) in the source code of the content interface. When the source code of the content interface is downloaded by a user device and the adapted script(s) embedded in the source code are executed on the user device during the rendering of the content interface, each adapted script generates a voting control for a corresponding content item on an instance of the content interface shown on the user device.

When authors of multiple content sources adopt the sample script provided by the centralizing server to generate respective voting controls for content items on their respective content interfaces, the centralizing server will be able to receive user votes for the content items of the multiple content sources, even if the multiple content sources are independent of one another and are completely uncoordinated with one another.

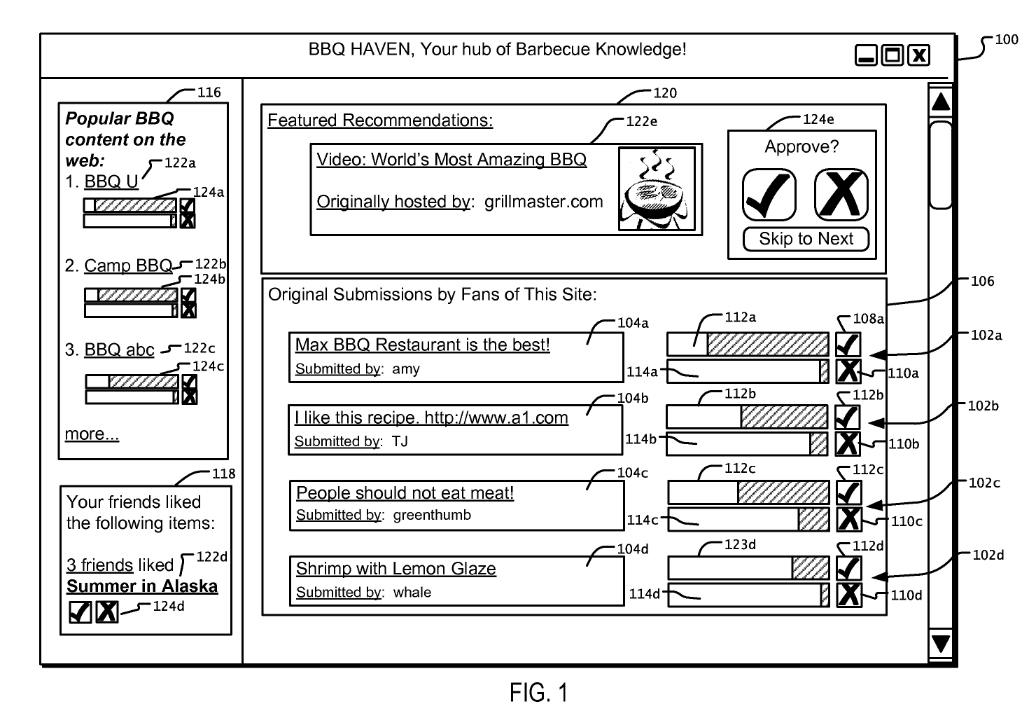

FIG. 1 is an example content interface 100 provided by an example content source, where the content interface 100 includes respective voting control(s) 102 for one or more content items 104 presented (e.g., either as the actual digital resources (e.g., the music files, images, videos, or text) hosted by the content source or as a referral element (e.g., a hyperlink, a summary, an icon) linking to the actual digital resources) on the content interface 100. In some implementations, the one or more content items 104 hosted by the content source can be provided in an original content area 106 in the content interface 100. In some implementations, each voting control 102 is an interactive user interface element configured to accept either user input representing a positive vote or user input representing a negative vote for the content item 104 associated with the voting control 102.

For example, as shown in the content interface 100, several content items 104 are presented in the original content area 106, each content item (e.g., content item 104a, 104b, or 104c) has a respective voting control (e.g., voting control 102a, 102b, or 102c) displayed in proximity to the content item 104. In some implementations, a user can select a first portion 108 (e.g., a checkmark or a thumbs-up symbol) of the voting control 102 to enter a positive vote, and a second portion 110 (e.g., a cross or a thumbs-down symbol) of the voting control to enter a negative vote for the content item associated with the voting control 102.

When the user enters a vote for a content item using the item's associated voting control 102 on the content interface 100, the user input causes the voting control (or its underlying script) to forward the vote to the centralizing server (e.g., at a designated Internet address specified in the script) as a vote submission for the content item. The vote submission identifies the content item, the content source, and the vote type (e.g., negative or positive) of the vote, for example, by respective identifiers of the content item, content source, and vote type.

The vote submissions may be anonymized in one or more ways before they are stored or used, so that personally identifiable information is removed. For example, a user's identity may be anonymized so that no personally identifiable information can be determined for the user and so that any identified user preferences or user interactions are generalized (for example, generalized based on the content identifiers, etc.) rather than associated with a particular user. Finally, the votes stored by the search system may be deleted after a predetermined period of time.

In some implementations, where users deliberately consent to participate in a more personally targeted service (e.g., targeted content recommendation service), the vote submission from these users may also identify the users, for example, by identifiers of the users' devices, user account identifiers (IDs) associated with the users registered with the content source, or user account IDs associated with the users registered with the centralizing server. The personally identifiable information of a user can be removed and deleted through one or more anonymizing procedures when the user indicates his or her wish to terminate the personally targeted service.

In some implementations, the voting control 102 of a content item 104 also presents respective vote counts of the positive votes and the negative votes that have been received for the content item 104 by the centralizing server. As shown in FIG. 1, each voting control 104 includes a first vote count bar 112 that indicates the number of positive votes that have been received for the content item 104, and a second vote count bar 114 that indicates the number of negative votes that have been received for the content item 104. As shown in FIG. 1, the first and second vote count bars can graphically indicate the relative number of positive votes and negative votes that have been received for the content item, and numerically indicate the absolute number of positive and negative votes that have been received for the content item. In some implementations, the vote counts can be represented in other numerical or graphical forms, e.g., as a pie chart or histogram.

In some implementations, the script for generating the voting control 102 on the content interface 100 is configured to send a vote count request to the centralizing server when the script is executed on a user device displaying the content interface 100. The vote count request identifies the content item associated with the voting control and requests the current vote counts (e.g., counts of positive and negative votes) that have been received by the centralizing server. In some implementations, the vote count request can be a Hypertext Markup Language (HTML) request. When the user device receives the current positive and negative vote counts from the centralizing server, the voting control 104 can be generated and inserted into the content interface with a portion of the voting control showing the current vote counts.

In some implementations, the author of a content interface can include one or more other scripts (e.g., one or more recommendation requesting script(s)) in the source code of the content interface 100 for retrieving one or more types of content recommendations from the centralizing server. The content recommendations enables visitors of a content interface provided by one content source to view content items hosted by other content sources without requiring the visitors to visit the content interfaces of those other content sources directly. Therefore, the content recommendations can broaden the viewership of content items for participating content sources and receive votes for the content items from a broader range of users.

Although for illustrative purposes, the example content interface 100 includes both an original content area 106 for showing original content items hosted by the content source and one or more recommendation areas (e.g., recommendation areas 116, 118, and 120) for showing content items hosted by other content sources, in actual practice, a content interface can include only an original content area, or only a recommendation area, or one or more of both types of content areas. In some implementations, the recommendation areas can be presented on content interfaces separate from the content interface showing the original content area. In some implementations, the content interface(s) showing one or more recommendation areas can be hosted by the centralizing server, or by other content sources that have implemented the content interfaces with the recommendation requesting script(s). A user can visit the recommendation content interface(s) hosted by the centralizing server or the other content sources directly, for example, by specifying respective web address(es) of the content interface(s) in a browser.

As shown in FIG. 1, one or more scripts for requesting content recommendations have been embedded in the source code of the content interface 100. When the source code is downloaded by a user device and the script(s) are executed on the user device, one or more example recommendation areas (e.g., the recommendation areas 116, 118, and 120) are provided within the content interface 100. In this example, the recommendation area 116 includes a ranked list of highly rated content items based on user votes collected at the centralizing server. The recommendation area 118 includes content items that are recommended based on votes submitted by other users related to the user viewing the content interface 100. The recommendation area 120 include featured content items that, according to the current votes received for the items, are likely to achieve high ratings if more people review and vote on the content items. The centralizing server can implement and provide other types of recommendations, and provide particular types of recommendations based on a recommendation type preference specified in the recommendation requests received from the user device.

In each of the recommendation areas (e.g., the recommendation areas 116, 118, and 120), one or more content recommendations 122 are presented. Each content recommendation 124 can be in the form of a referral element (e.g., a link) that refers to a respective content item hosted by a respective original content source, or in the form of a duplicate of the actual digital resource (e.g., image, or text) of the content item. In general, a referral element can be a user interface element, which, when selected by a user on the user device, causes the content item referred to by the referral element to be retrieve from a host (e.g., either the centralizing server or the original content source of the content item) and presented on the user device. In some implementations, the referral element can provide a title, an icon, or a short summary for the content item that is referred to by the referral element 116. In some implementations, a referral element can refer to a duplicate of the content item hosted by an original content source, where the duplicate is hosted by the centralizing server.

As shown in FIG. 1, each recommended content item 122 in the recommendation areas 116, 118, and 120, is presented with a respective voting control 122. The respective voting control 124 has the function of accepting votes from the user of the user device and forwarding the received votes to the centralizing server in a vote submission. Optionally, the voting control 124 also presents the current votes accumulated for the recommended content item at the centralizing server. The voting controls (e.g., voting controls 102 and 124) in recommendation areas and the original content area(s) may have the same appearance or different appearances, depending on whether customization of the voting control appearances is permitted by the centralizing server.

In this example, the recommendation area 116 includes a ranked list of highly rated content items (e.g., as recommendations) based on user votes collected at the centralizing server. The ranking of the content items are based on respective quality or popularity scores computed from the current votes received for the content items at the centralizing server. Content items having higher quality or popularity scores are believed to have better quality or user preferences than content items having lower scores. A large number of positive votes with a relative small number of negative votes on an item can indicate general user approval or preference of the content item, or better quality of the content item. Therefore, in some implementations, an approval ratio (e.g., a ratio of positive vote count and negative vote count) or an absolute vote count (e.g., the different between positive vote count and negative vote count) can be used to calculate the scores used for the ranking the content items. In some implementations, only a single type of votes (e.g., only positive votes or only negative votes) are collected and used to rank the content items. In these implementations, the voting controls presented on the content interfaces (e.g., the example content interface 100) can be simplified to only collect one type of votes (e.g., either positive or negative votes) and show the vote count of that type of votes.

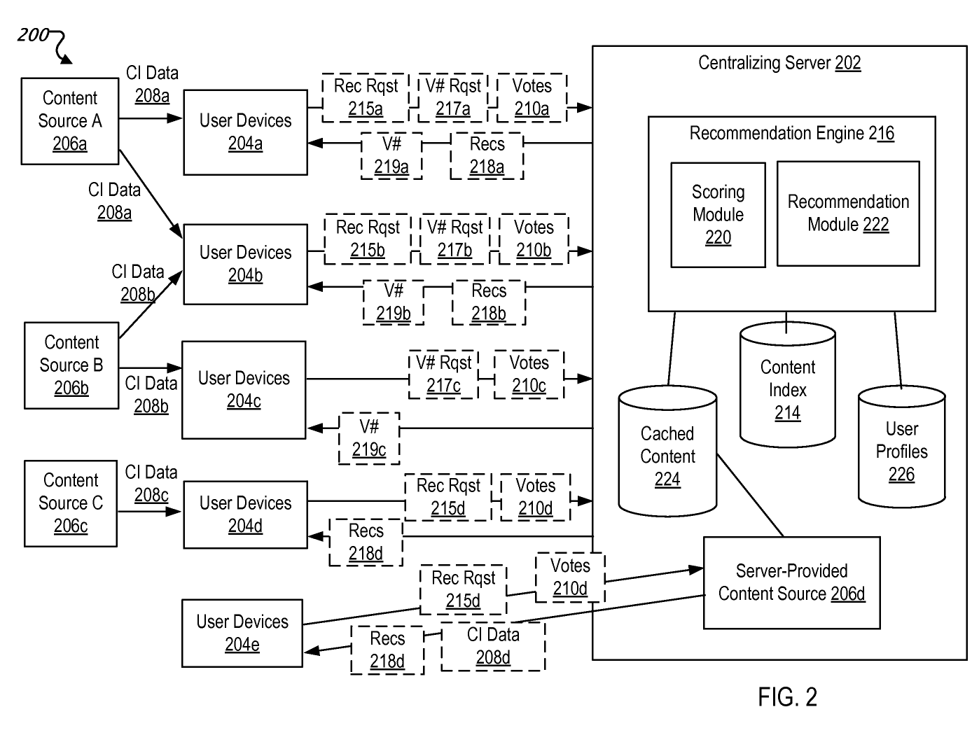

In some implementations, the respective scores of the content items can take into account not only the absolute and/or relative number of positive and negative votes received from each content item, but also the total number of votes currently received for the content item, such that the accuracy and fidelity of the scores can be improved. In some implementations, a statistical confidence interval of the votes can be calculated for each content item based on the votes received at the centralizing server, and the score can be calculated based on the confidence interval (e.g., a lower bound of the statistical confidence interval can be used as a quality or popularity score for the content items). More details on how the scores are computed for each type of recommendations are provided in the description accompanying FIG. 2.

In some implementations, the ranked list of highly rated content items presented in the recommendation area 116 can be a subset of highly rated content items that have been filtered based on one or more recommendation criteria in addition to a threshold quality or popularity score. For example, recommendation criteria can be based on subject matter, content type, content submission time, and so on. In some implementations, the recommendation script can specify one or more recommendation criteria, and the centralizing server can provide recommendations accordingly based on the specified recommendation criteria of each recommendation request.

In this example, the recommendation area 118 includes content items that are recommended based on votes submitted by other users related to the user viewing the content interface 100. For example, the user can register for a service at the centralizing server that allows the user to relate to one or more other users who have also registered for the service. When more than a threshold hold number of users that are related to the user have submitted positive votes for a content item, the centralizing server can provide the content item to the user as a content recommendation (e.g., the content recommendation 122d) in the recommendation area 118. Other ways of relating users are possible (e.g., by the users' voting patterns, or stated interest or demographics).

The recommendation area 120 include featured content items (e.g., content recommendation 122e) that, according to the current votes received for the items, are likely to achieve high ratings if more people review and vote on the content items. In some implementations, a respective voting priority score can be computed for each content item based on a statistical confidence interval of the votes for the content item that have been received at the centralizing server, and content items having high voting priority scores are more likely to be selected as featured items for additional voting and provided in response to recommendation requests for featured recommendations. In some implementations, a higher bound of the statistical confidence interval of each content item can be used to calculate to the voting priority score for the content item. More details on how the voting priority scores are computed are provided in the description accompanying FIG. 2.

FIG. 2 illustrates an example online environment 200 in which a centralizing server 202 operates. In the example online environment 200, users (e.g., using user devices 204) communicate with one or more content sources 206 (e.g., servers of websites, online discussion boards, or online social networks) and the centralizing server 202 through one or more networks. Examples of the networks include combinations of one or more local area networks (LAN), wide area networks (WAN), peer-to-peer networks, wireless networks, and/or other equivalent communication networks. The centralizing server 202 can be implemented on one or more data processing apparatus. The user devices 204 can be data processing apparatus such as personal computers, smart phones, tablet computers, and so on.

Each user device 204 includes software application(s) (e.g., web browsers or other networked applications) that download data 208 (e.g., source code) for generating content interfaces (e.g., the content interface 100 shown in FIG. 1) from content sources 206, and render the content interfaces on the user device 204 according to the data 208. The software application(s) are further able to transmit vote submissions 210, vote count requests 217, and recommendation requests 215 to the centralizing server 202, and to receive vote counts 219 and content recommendations 218 from the centralizing server 202 according to the instructions specified in the script(s) embedded in the source code of the content interfaces.

As shown in FIG. 2, each content source 202 can communicate with multiple user devices 204, and each user device 204 can communicate with multiple content sources 206. However, each content source 206 may attract visits from only a subset of all users in the online environment 200 and establish communication with a subset of user devices among all user devices 204 in the online environment 200. For example, user devices 204a have only established communication with the content source 206a, user devices 204c have only established communication with the content source 206b, user devices 204b have established communications with both the content source 206a and 206b, while user devices 204d has not established communications with either of the content sources 206a and 206b.

In some implementations, when a user accesses a content interface of a content source 206 (e.g., content source 206a) using a user device 204 (e.g., one of the user devices 204a), the software application (e.g., a browser) on the user device 204 (e.g., the user device 204a) downloads data 208 (e.g., source code 208a) from the content source 206 (e.g., the user device 204a) that specifies how the content interface of the content source 206 (e.g., the content source 206a) should be rendered on the user device 204 (e.g., the user device 204a). For example, the data can be the source code of an HTML page that has one or more embedded scripts for generating respective voting controls (e.g., the voting controls 102 shown in FIG. 1) for one or more content items that are provided on the content interface. The software application on the user device 204 (e.g., the user device 204a) executes the one or more embedded scripts as part of the rendering process. The executed script generates the user interface elements of the voting controls, and places the user interface elements at appropriate locations (e.g., in proximity to the content item with which the voting control is associated) on the content interface shown on the user device 204 (e.g., the user device 204a).

In some implementations, the user interface element of each voting control is configured to receive user input representing a vote for the content item associated with the voting control, and a programming element (e.g., an underlying script) of the voting control is configured to prepare a vote submission 210, and transmit the vote submission 210 to the centralizing server 202.

In some implementations, the script for generating a voting control is also configured to send a vote count request 217 to the centralizing server 202, receive the current vote counts for the associated content item, and present the current vote counts near or within the user interface element of the voting control on the content interface (e.g., as shown by the vote count bars 112 and 114 in FIG. 1).

In some implementations, a reference to the script can be embedded in the source code of the content interface, and the software application for rendering the content interface on the user device can download the script from a designated server according to the reference embedded in the source code of the content interface. One advantage of using a reference to the script in the source code instead of the whole script is that a referenced script can be changed and improved by the provider of the script (e.g., the centralizing server) without requiring the authors of the content interfaces to update the source code of their content interfaces.

As set forth earlier with respect to FIG. 1, the vote submission 210 identifies the content item (e.g., by a Uniform Resource Locator (URL) of the content item, or an item identifier in conjunction with a URL of the content interface) for which the vote submission is being provided. Optionally, the vote submission 210 also include a token or identifier associated with the user device 204 from which the vote was submitted or a user account from which the vote is submitted. In some implementations, the content source 206 can require the user accessing the content interface to pass an authentication process, for example, by requiring the user to submit a user ID and password combination, to ensure that each user only votes once for each content item.

In some implementations, each user can obtain a unique user ID and password combination from the centralizing user 202, for example, through a registration process. The centralizing server 202 can delegate the ability to authenticate the user ID and password combination of each registered user to one or more trusted content sources 206, for example, by making the user ID and password combination publically verifiable. Once a trusted content source verifies a user ID and password combination of a user, the trusted content sources can provide a token (e.g., a cryptographically signed and verifiable string) to the user, such that votes submitted by the user can be sent to the centralizing server with the token (e.g., cryptographically signed using the token), and the centralizing server can verify the token to confirm that the user has been authenticated by the trusted content source and that the user has only voted on the content item once.

In some implementations, in addition to, or alternative to, user identities (e.g., unique user ID and password combinations) provided by the centralizing server 202, the centralizing server 202 can accept user identities provided by one or more trusted content sources and/or third party identity providers. For example, once the user has passed the authentication process at a trusted content source or third party identity provider using a user ID and password combination provided by the trusted content source or third party identity provider, the user can be provided with a token (e.g., a token that is cryptographically signed by the trusted content source or third party identity provider and verifiable by the centralizing server). Votes submitted by the authenticated user can then be sent with the token (e.g., cryptographically signed with the token) to the centralizing server, where the centralizing server can verify the token to determine whether the user has been authenticated, and whether the vote is a unique (non-duplicate) vote.

Various cryptographic and authentication techniques can be utilized to support the delegated identity providing and authentication processes. In addition, various techniques can be used to allow the authentication to be performed and votes verified without revealing any personally identifiable information of the voting users to the centralizing server 202. In some implementations, optionally, the user ID of a user is send with the votes of the user to the centralizing server 202 with the user's permission, for the user to receive personalized recommendations from the centralizing server 202.

As shown in FIG. 2, the centralizing server 202 includes a content index 214. The content index 214 includes entries that are associated with content items for which the centralizing server 202 has received votes from user devices 204, e.g., through the respective voting controls presented on the content interfaces of the content sources 206. In some implementations, each entry in the content index 214 can include a content identifier that uniquely identifies a content item hosted by a respective original content source. The content index 214 include entries for content items that are hosted by multiple content sources across the Internet, including both content sources that have arrangements to share content items and content sources that are independent and uncoordinated with one another. In some implementations, the content item may appear on more than one content interface of the hosting content source, but counts as a single entry in the content index 214.

In addition to the content identifier, the entry of a content item in the content index 214 can include a current positive vote count for the content item and a current negative vote count for the content item based on votes that the centralizing server has received for the content item. As set forth with respect to FIG. 1, a content item hosted by an original content source may be presented to users through one or more recommendation interfaces provided by another content source or by the centralizing server, and receive votes through voting controls on the recommendation interfaces. Therefore, the current positive vote counts in the content index tally both the votes received through the voting controls on the content interface(s) of the original content source hosting the content item and the votes received by the content items as content recommendations through the voting controls on the recommendation interfaces.

When the centralizing server 202 receives a vote submission 210 from a user device 204 for a content item, the centralizing server 202 identifies the content item in the content index 214 based on the content identifier in the content submission 210, and increments either the positive vote count or the negative vote count for the content item depending on the vote type specified in the vote submission 210.

In some implementations, when a vote submission 210 for a content item is received, if a content item does not already have an entry in the content index 214, the centralizing server 202 can create a new entry for the content item in the content index 214, and assign a new content identifier to the content item. The centralizing server can further set the current vote count for the content item to one vote of the vote type specified in the vote submission 210.

When the centralizing server 202 receives a vote count request 217 for a content item from a user device 204, the centralizing server 202 identifies the entry of the content item based on an identifier of the content item specified in the vote count request 217, and returns the current vote counts associated with the content item recorded in the entry to the requesting user device 204.

In some implementations, when a vote count request 217 is received by the centralizing server 202, if an entry for the content item has not been created in the content index 214, the centralizing server can create the entry, and set the current vote counts of the content item to zero for both the negative vote count and the positive vote count. Then, the centralizing server 202 can respond to the vote count request by providing a vote count of zero to the requesting user device 204.

In some implementations, the content index 214 may also include information that categorize the content items by subject matter, content source, owner, content type, content submission time, and so on. The additional information can be used by the centralizing server to filter the content items and prepare recommendations based on different recommendation criteria that may be specified in recommendation requests 215 received from user devices 204.

The centralizing server 202 also includes a recommendation engine 216. The recommendation engine 216 can respond to recommendation requests 215 received from user devices 204 and provide content recommendations 218 to the requesting user devices 204 according to the information specified in the recommendation request.

As shown in FIG. 2, the recommendation engine 216 can include a scoring module 220 and recommendation module 222. The scoring module 220 can calculate various types of scores (e.g., popularity or quality scores, or voting priority scores) for each content item in the content index 214 based on the current vote counts registered for each content item in the content index 214. The scoring can be performed periodically, or as new votes are continuously received at the centralizing server 202.

In some implementations, one score that can be calculated based on the current vote counts of each content item is a popularity score. The popularity score is an indicator of how well received or favored a content item is relative to other content items. In some implementations, the popularity scores can be used as an indicator of content quality based on user opinions of the content items, and the popularity score of the content item can be used as the quality score of the content item or counts as a portion of the quality score of the content item. In some implementations, a voting priority score can be calculated for each content item based on the current vote counts for each content item. The voting priority score is a measure of how likely a content item will obtain a high popularity score or quality score if the content item were shown to more users and received more votes from the users.

In some implementations, any one of the popularity score, the quality score, and the voting priority score can be used as a criterion for selecting content items as recommended items for users. The recommendation request can specify a requested recommendation type, such that the appropriate scores are used to select the content recommendations. In some implementations, the various types of scores calculated for the content items can be stored in the content index 214 in association with the respective content items.

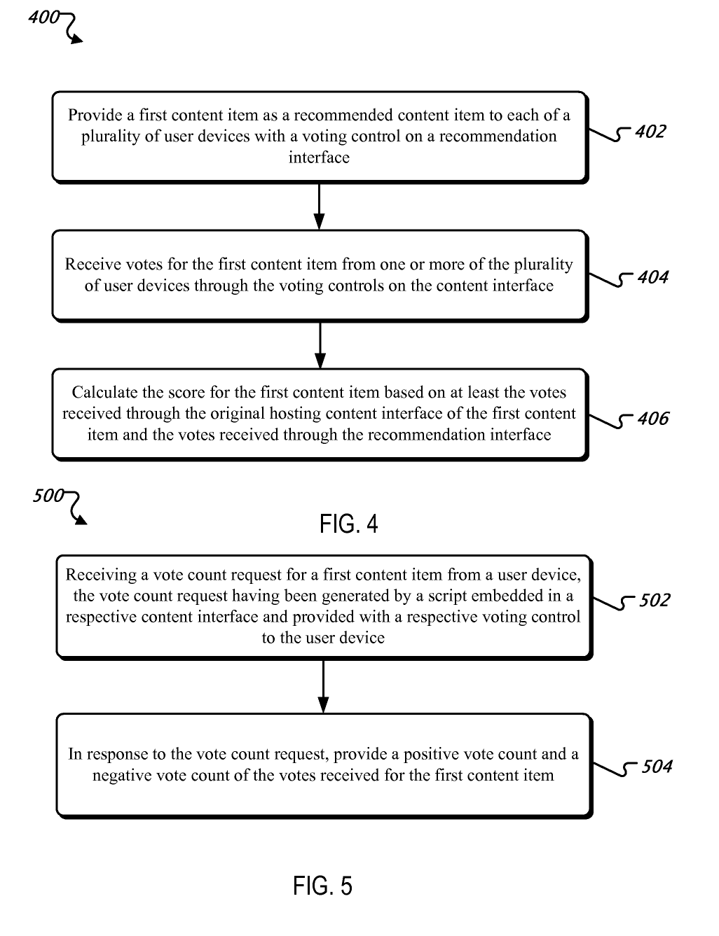

In some implementations, the recommendation engine 216 ranks the content items based on each type of scores computed for the content items. For example, the recommendation engine 216 can generate a ranking of content items based on the popularity scores of the content items. A set of top-ranked (e.g., top 100) can be identified as popular content items available on the web, and provided to user devices 204 in response to recommendation requests that request popular content (e.g., as shown by the content items in the recommendation area 216 in FIG. 4).

In some implementations, only a subset of the top-ranked content items are provided in response to each recommendation request, and the content items in the set of top-ranked content items can be randomly selected according to a selection frequency assigned to each content item. The selection frequency can be the same for all of the top-ranked content items or weighted by the popularity scores of the top-ranked content items.

In some implementations, the recommendation engine 216 can also provide one or more featured content items to users in response to recommendation requests 215 that request the featured recommendations. In some implementations, the content items are ranked according to the voting priority scores of the content items. A set of top-ranked content items according to the voting priority score can be identified, and the set of top-ranked content items can be provided to users as featured recommendations. In some implementations, only a subset of the top-ranked featured content items is provided in response to each recommendation request that requests featured recommendations. The subset of the featured content items can be randomly selected according to a selection frequency to ensure that each top-ranked featured content item is shown to users at least as frequently as the selection frequency.

In some implementations, the popularity score (or quality score) or the voting priority score for each content item is computed based on a statistical confidence interval of a respective approval ratio for the content item. The approval ratio of a content item is a ratio between the number of positive votes and the number of negative votes a content item has received. The statistical confidence interval of an approval ratio takes into account both the current value of the approval ratio and the number of votes accumulated for each content submission.

In some implementations, the lower bound of the statistical confidence interval associated with a content item serves as a pessimistic estimate of the true quality or popularity of the content item based on the currently available votes. When there are only a small number of votes accumulated for a content item, the lower bound of the statistical confidence interval is below and can depart widely from the current value of the approval ratio for the content item. As additional votes accumulate for the content item, the value of the approval ratio is adjusted by the additional votes and the lower bound of the statistical confidence interval converges toward the current value of the approval ratio, which approaches the true popularity or quality level of the content item. Therefore, in some implementations, the lower bound of the statistical confidence interval can be used to calculate the popularity (or quality) scores of the content items. Content items with high value for the lower bound of the statistical confidence interval have more likelihood of being popular or have good quality as compared to content items with a low value for the lower bound of the statistical confidence interval.

In some implementations, the upper bound of the statistical confidence interval associated with a content item serves as an optimistic estimate of the true popularity (or quality) of the content submission based on the currently available votes. When there are only a small number of votes accumulated for a content item, the upper bound of the statistical confidence interval is above and can depart widely from the current value of the approval ratio for the content submission. As additional votes accumulate for the content item, the value of the approval ratio is adjusted by the additional votes and the upper bound of the statistical confidence interval converges toward the current value of the approval ratio, which approaches the true popularity or quality level of the content item. By using the upper bound of the statistical confidence interval as a voting priority score for the content items, content items that have shown good promise to become popular content items are given more voting opportunities (e.g., as featured recommendations) based on their higher voting priority scores.

In some implementations, the scoring formula for calculating the lower bound of the statistical confidence interval scales down the current value of the respective approval ratio by a decreasing amount with an increasing vote count for the content submission. An example of the scoring formula is a formula for calculating the lower bound of a Wilson score interval. Other scoring formulae for calculating the lower bounds of the statistical confidence intervals of the approval ratios are possible

In some implementations, the scoring formula for calculating the upper bound of the statistical confidence interval scales up the current value of the respective approval ratio by a decreasing amount with an increasing vote count for the content item. An example of the scoring formula is a formula for calculating the upper bound of a Wilson score interval. Other scoring formulae for calculating the upper bounds of the statistical confidence intervals of the approval ratios are possible.

In some implementations, the recommendation module 222 can filter the recommendations provided to the user devices 204 based on various recommendation criteria. In some implementations, the recommendation criteria can be varied based on the specification in the recommendation request, and optionally, characteristics associated with the user or user device to which the recommendations are being provided. In some implementations, the recommendation criteria can include a minimum score (e.g., a threshold popularity, quality, or voting priority score) or rank (e.g., above top 100) that a content item should meet before the content item is provided as a content recommendation. In addition, the recommendation criteria can include one or more particular topical categories, content types, submission times, languages, and so on that the recommended content items should satisfy before the recommended content items are provided to users.

As shown in FIG. 2, a content source (e.g., content source 206a) can provide a content interface that includes a recommendation area (e.g., the recommendation areas 116, 118 and 120 shown in FIG. 1) in which content recommendations can be presented. In some implementations, the source code of the content interface has an embedded script that is configured to send a recommendation request 215 to the centralizing server 202 when executed on a user device (e.g., user device 204a). The recommendation request 215 can be an HTTP request that specifies the web address of the user device, and optionally the type of recommendations (e.g., either popular or featured content items), and/or one or more recommendation criteria. Each content interface can include one or more recommendation areas for presenting different types of recommendations, or recommendations that satisfy different recommendation criteria.

In some implementations, some content sources (e.g., content source 206a) present content recommendations in addition to the content items hosted by the content source. In some implementations, some content sources (e.g., content source 206c) present only content recommendations provided by the centralizing server 202, and do not host any original content items.

In some implementations, the centralizing server 202 can store a duplicate copy of some or all of the top-ranked content items in a cached content repository 224. The cached content repository can include content items that are originally hosted by multiple content sources (e.g., content sources 206a and 206b). When the recommended content is provided to a user device 204 through a content interface of a content source (e.g., content source 206c), the duplicate copy is sent to the user device and displaying the content interface of the content source (e.g., content source 206c). In some implementations, the centralizing server 202 can implement one or more content sources (e.g., content source 206d), and the user devices 204 can access the server-provided content sources 206d directly and submit votes on the through the voting controls on the content interface of the server-provided content sources 206d.

In some implementations, users visiting the recommendation interface of the content sources 206 can submit votes for one or more of the recommended content items without visiting the original hosting content sources of the one or more recommended content items. In some implementations, the cached content repository 224 can store the content identifier of the cached content items, such that votes received for the cached content items can be attributed to the correct content item entry in the content index 214. In some implementations, the referral elements in the recommendation interface can redirect the user to the original hosting content sources of the recommended content items, such that votes can be submitted using the voting controls on the content interfaces of the original hosting content sources.

In some implementations, the centralizing server 202 also includes a profile repository 226. The profile repository 206 can include one or more profiles associated with each user or user device 204 that have opted for personalized recommendation services provided by the centralizing server 202. For example, content items can be categorized into different content types. A voting profile can be developed by the centralizing server 202 for a user based on the types of content items reviewed by the user and the types of votes submitted by the user for the reviewed content items. The user's interests, likes, and dislikes can be inferred from the voting patterns of the user, and the profile can reflect the user's interest, and likes and dislikes. Based on the profile, the centralizing server 202 can provide tailored recommendations that suit the user's interests and preferences. Since building the user profile requires the voting data of the user be collected and analyzed, therefore, an opt-in process can be implemented for users to provide explicit consent to participate in such vote storing and analysis. The user profiles and any personally identifiable information can be removed when the user terminates such services.

In some implementations, multiple user profiles can be related to one another by the centralizing server 202 based on the similarities between the kinds of content items that the users associated with the user profiles have expressed favor or disfavor. For example, if a first user consistently submitted positive votes for pop music items, and negative votes for rap music items, and a second user also consistently submitted positive votes for pop music items, and negative votes for rap music, then based on the voting patterns of the two users, the profiles of the two users can be related to each other by the centralizing server 202. If the first user subsequently provided a positive vote for a content item that has not been viewed by the second user, the centralizing server 202 can recommend the content item to the second user through a recommendation interface. In some implementations, if the first user has submitted a negative vote for a content item, the centralizing server 202 can prevent the content item from being presented to the second user as a recommendation even if the content item otherwise qualifies to be recommended to the second user.

In some implementations, the centralizing server 202 also uses the characteristic information stored in the content index 214 to select items for recommendation to users, such that the characteristics of the recommended items meet the preferences specified in the users' respective profiles.

In some implementations, user profiles can also be related to one another based on other criteria. For example, the centralizing server 202 may provide an option for a user to link the user's profile with the profiles of one or more friends of the user. Such that content favorably voted by one or more friends of the user can be provided as a recommendation to the user.

The centralizing server 202 is merely illustrative. More or fewer components may be implemented in the centralizing server 202. The various functions of the centralizing server 202 may be distributed among a network of computers and systems, and the components of the centralizing server 202 does not have to be located in the same geographic location.

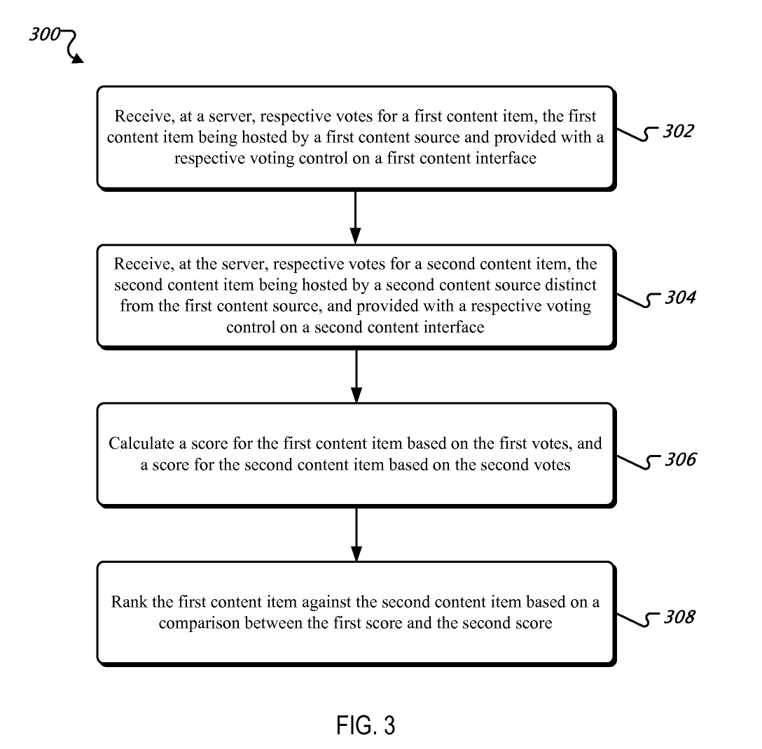

FIG. 3 is a flow diagram of an example process 300 for ranking content items hosted by multiple distinct content sources based on user votes. The example process can be performed by the centralizing server 202 shown in FIG. 2, for example.

In the example process 300, the centralizing server receives respective votes for a first content item from a first plurality of user devices, where the first content item is hosted by a first content source and provided to each of the first plurality of user devices with a respective first voting control on a first content interface (302). In addition, the centralizing server also receives respective votes for a second content item from a second plurality of user devices, where the second content item is hosted by a second content source distinct from the first content source (304). The second content item is provided to each of the second plurality of user devices with a respective second voting control on a second content interface (e.g., a content interface of the second content source). Each voting control is configured (e.g., by the underlying script for generating the voting control) to accept a vote for a respective content item on a respective user device and transmit the accepted vote to the centralizing server. The centralizing server calculates a first score for the first content item based at least in part on the first votes, and a second score for the second content item based at least in part on the second votes (306). Then, the centralizing server ranks the first content item against the second content item based at least in part on a comparison between the first score and the second score (308). In the above process, it has been determined (e.g., by the centralizing server) that the first content item and the second content item are distinct content items.

In some implementations, the first votes include at least a positive vote and at least a negative vote for the first content item. In some implementations, the first score is based on a statistical confidence interval of the votes for the first content item, and the second score is based on a statistical confidence interval of the votes for the second item. In some implementations, only one type of votes (e.g., either positive or negative votes) is collected by the centralizing user, and the ranking is based on the one type of votes only. However, using both positive votes and negative votes, and the statistical confidence intervals of the votes to score the content items can allow content items with significantly different audience sizes to be ranked more fairly against one another.

In some implementations, the first content source and the second content source are two distinct websites, and the first content interface and the second interface are respective one or more webpages of the two distinct websites, respectively.

In some implementations, data for generating the first content interface is provided to each of the first plurality of client devices with an accompanying script, and the accompanying script is configured to generate the respective voting control for the first content item when executed on the client device.

Although the above process 300 is described with two content items hosted by two distinct content sources, the process 300 can be applied to many content items hosted on many distinct and/or same content sources.

FIG. 4 is a flow diagram of an example process 400 for providing content recommendations for content items from multiple content sources across multiple content sources, and collecting votes on the recommended content items. The example process 400 can be performed by the centralizing server 202 shown in FIG. 2. In the example process 400, assume that the first content item is hosted by a first content source, and votes have been received for the first content item through the voting control on the content interface of the first content source.

In the process 400, the centralizing server provide the first content item as a recommended content item to each of a plurality of user devices with a respective voting control on a content interface distinct from the content interface of the first content source (402). The content interface for providing the recommended content item can be a recommendation interface (e.g., the recommendation areas 116, 118, or 120 shown in FIG. 1) embedded in a content interface of another content source or as a standalone content interface (e.g., a content interface provided by the content source 206c or by the server-provided content source 206d shown in FIG. 2).

The centralizing server can receive one or more votes for the first content item from one or more of the plurality of user devices through the voting controls shown on the recommendation interface (404). The centralizing server can then calculate the first score for the first content item based on at least the votes through the voting controls on the content interface of the original hosting content source and the voting controls on the recommendation interface (406).

Although the process 400 is described with respect to a single recommendation interface that provides the first content item as a recommended item, the process 400 can also be applied to multiple recommendation interfaces that present the first content item as recommended items. Similarly, the process 400 can be applied to other content items for which votes have been received from the respective content interfaces of the content items original content sources.

FIG. 5 is a flow diagram of an example process 500 for providing a current vote count for a content item with a voting control for the content item on a content interface. The process 500 can be performed by the centralizing server shown in FIG. 2, for example.

In the process 500, the centralizing server receives a vote count request for a first content item from a user device, the vote count request having been generated by a script embedded in a respective content interface and provided with a respective voting control to the user device (502). In response to the vote count request, the centralizing server provides a positive vote count and a negative vote count of the respective votes that have been received for the first content item at the centralizing server (504).

In some implementations, the user device presents the positive vote count and the negative vote count for the first content item within or in proximity to the respective voting control on the content interface shown on the user device.

In some implementations, the centralizing server provides the first content item to each of a plurality of user devices with a voting control on a recommendation interface, and receives one or more votes for the first content item from one or more of the plurality of user devices through the recommendation interface. Then, the positive vote count and the negative vote count for the first content item are provided to the requesting user device are based on at least the votes received through the original hosting content interface hosting the first content item and the votes received through the recommendation interface.

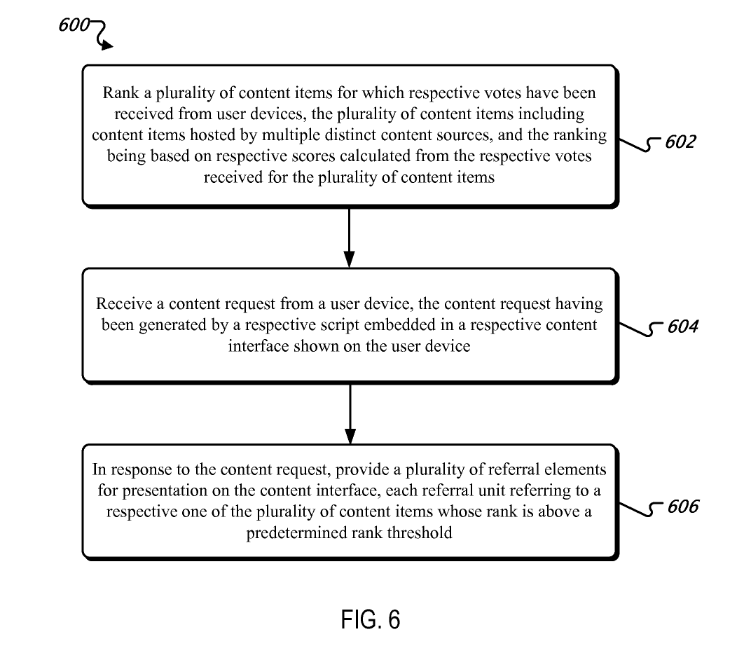

FIG. 6 is a flow diagram of an example process 600 for providing a ranking of content items hosted by multiple content sources based on respective votes received for the content items. The process 600 can be performed by the centralizing server 202 shown in FIG. 2, for example.

In the example process 600, the centralizing server ranks a plurality of content items for which respective votes have been received from user devices, where the plurality of content items include content items hosted by multiple distinct and uncoordinated content sources, and the ranking is based on at least on respective scores calculated from the respective votes received for the plurality of content items (602).

The centralizing server receives a content request from a user device, where the content request has been generated by a respective script embedded in a respective content interface shown on the user device (604). For example, the user interface can be a recommendation interface for displaying popular items or featured items. In response to the content request, the centralizing server can provide a plurality of referral elements for presentation on the content interface (606).

In some implementations, each referral unit refers to a respective one of the plurality of content items whose rank is above a predetermined rank threshold.

In some implementations, the user device is associated with a respective profile, and the centralizing server identifies the plurality of content items based on the respective profile associated with the user device. For example, each of the plurality of content items selected is required to have received a favorable vote from at least one other user device that is associated with a respective profile related to the respective profile associated with the user device.

In some implementations, the centralizing server generates respective profiles for two or more user devices based at least on characteristics of respective content items for which votes have been received from each of the two or more user devices, and the respective vote that was given to each of the respective content items by the user device.

In some implementations, the respective profile of a user device can be related to the respective profile of at least one other user device by voting patterns associated with the user devices. In some implementations, the respective profile of a user device can be related to the respective profiles of at least one other user device by mutual user consent.

The example processes shown in FIGS. 3-6 are merely illustrative, other processes and functions are described in other parts of the specification, for example, with respect to FIGS. 1 and 2.

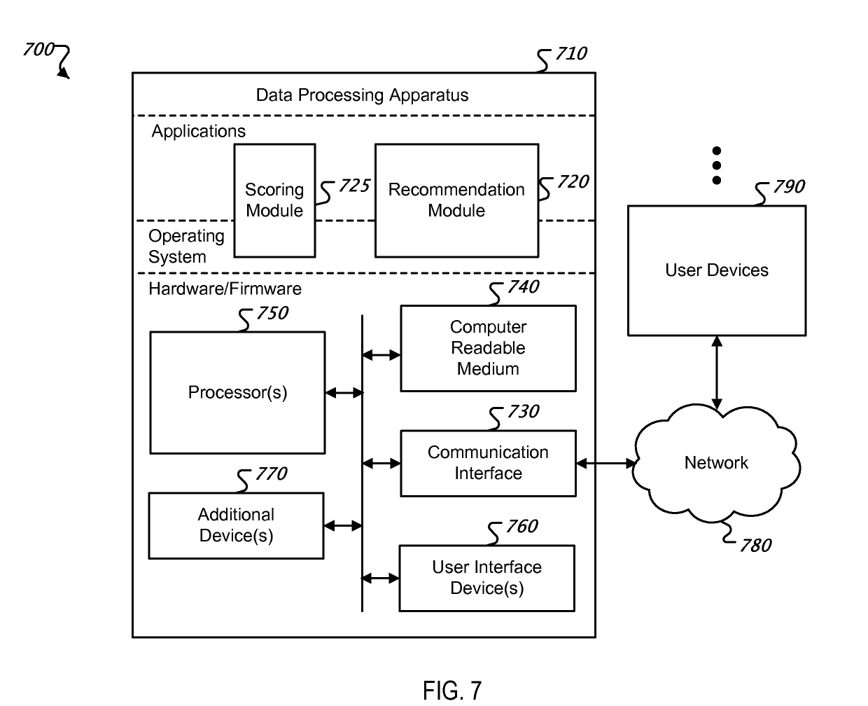

FIG. 7 is a schematic diagram of an example online environment 700. The environment 700 includes a server system 710 communicating with user devices 790 through a network 780, e.g., the Internet. The user device 790 is one or more data processing apparatus. Users interact with the user devices 790 through application software such as web browsers or other applications.

The server 710 is one or more data processing apparatus and has hardware or firmware devices including one or more processors 750, one or more additional devices 770, a computer readable medium 740, and one or more user interface devices 760. User interface devices 760 can include, for example, a display, a camera, a speaker, a microphone, a tactile feedback device, a keyboard, and a mouse. The server 710 uses its communication interface 730 to communicate with user devices 790 through the network 780. For example, the server 710 can receive vote submissions from the client devices 790 and to receive recommendation requests or vote count requests for content recommendations and vote statistics, for instance, through its communication interface 730, and can provide user interfaces (e.g., a recommendation interface 116, 118, and 120 shown in FIG. 1) to client devices 790 through its communication interface 730.

In various implementations, the server 710 includes various modules, e.g. executable software programs. In various implementations, these modules include a scoring module 725 and a recommendation module 720. The scoring module 725 calculates the popularity scores and voting recommendation scores for content items based on received votes and optionally ranks the content items according to the scores. The recommendation module 720 can provide content recommendations based on recommendation requests received from user devices and the rankings of the content items based on various scores.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by a data processing apparatus, the method comprising:
receiving, at a server, from a first plurality of user devices respective first votes for a first content item, the first content item being hosted by a first content source and provided to each of the first plurality of user devices with a respective first voting control on a respective first content user interface;
receiving, at the server, from a second plurality of user devices respective second votes for a second content item, the second content item being hosted by a second content source distinct from the first content source, and provided to each of the second plurality of user devices with a respective second voting control on a respective second content user interface, wherein each of the first voting controls and the second voting controls is configured to transmit a respective vote received on a respective user device to the server;
calculating a first score for the first content item based at least in part on the first votes, and a second score for the second content item based at least in part on the second votes; and
ranking the first content item hosted by the first content source and the second content item hosted by the second, distinct content source, based at least in part on the first score of the first content item and the second score of the second content item.

2. The method of claim 1, wherein the first votes include at least a positive vote and at least a negative vote for the first content item, and wherein the first score is based on a first statistical confidence interval of the first votes and the second score is based on a second statistical confidence interval of the second votes.

3. The method of claim 1, wherein the first content source and the second content source are two distinct websites, and the first content user interface and the second user interface are respective one or more webpages of the two distinct websites, respectively.

4. The method of claim 1, wherein data for generating the first content user interface is provided to each of the first plurality of client devices with an accompanying script, and the accompanying script is configured to generate the respective first voting control when executed on the client device.

5. The method of claim 1, further comprising:
providing the first content item as a recommended content item to each of a third plurality of user devices with a respective third voting control on a respective third content user interface;
receiving respective one or more third votes for the first content item from one or more of the third plurality of user devices through one or more of the respective third voting controls; and
calculating the first score for the first content item based on at least the first votes and the respective one or more third votes.

6. The method of claim 1, further comprising:
receiving a vote count request for the first content item from a third user device, the vote count request having been generated by a script that had been embedded in a respective third content user interface provided to the third user device; and
in response to the vote count request, providing a positive vote count and a negative vote count of the respective first votes.

7. The method of claim 6, wherein the third user device presents the positive vote count and the negative vote count for the first content item within or in proximity to the respective first voting control on the respective third content user interface shown on the third user device.

8. The method of claim 6, further comprising:
providing the first content item to each of a fourth plurality of user devices with a respective fourth voting control on a respective fourth content user interface; and
receiving respective one or more fourth votes for the first content item from one or more of the fourth plurality of user devices,
wherein the positive vote count and the negative vote count for the first content item are based on at least the respective first votes and the respective one or more fourth votes for the first content item.

9. The method of claim 1, further comprising:
ranking a plurality of content items for which respective votes have been received from user devices, the plurality of content items including at least the first content item and the second content item, and the ranking being based on at least on respective scores calculated from the respective votes received for the plurality of content items;
receiving a content request from a third user device, the content request having been generated by a respective script embedded in a respective third content user interface shown on the third user device; and
in response to the content request, providing a plurality of referral elements for presentation on the third content user interface, each referral unit referring to a respective one of the plurality of content items whose rank is above a predetermined rank threshold.

10. A computer-readable medium having instructions stored thereon, the instructions, when executed by one or more processors, cause the processors to perform operations comprising:
receiving, at a server, from a first plurality of user devices respective first votes for a first content item, the first content item being hosted by a first content source and provided to each of the first plurality of user devices with a respective first voting control on a respective first content user interface;
receiving, at the server, from a second plurality of user devices respective second votes for a second content item, the second content item being hosted by a second content source distinct from the first content source, and provided to each of the second plurality of user devices with a respective second voting control on a respective second content user interface, wherein each of the first voting controls and the second voting controls is configured to transmit a respective vote received on a respective user device to the server;
calculating a first score for the first content item based at least in part on the first votes, and a second score for the second content item based at least in part on the second votes; and
ranking the first content item hosted by the first content source and the second content item hosted by the second, distinct content source, based at least in part on the first score of the first content item and the second score of the second content item.

11. The computer-readable medium of claim 10, wherein the first votes include at least a positive vote and at least a negative vote for the first content item, and wherein the first score is based on a first statistical confidence interval of the first votes and the second score is based on a second statistical confidence interval of the second votes.

12. The computer-readable medium of claim 10, wherein the first content source and the second content source are two distinct websites, and the first content user interface and the second user interface are respective one or more webpages of the two distinct websites, respectively.

13. The computer-readable medium of claim 10, wherein data for generating the first content user interface is provided to each of the first plurality of client devices with an accompanying script, and the accompanying script is configured to generate the respective first voting control when executed on the client device.

14. The computer-readable medium of claim 10, wherein the operations further comprise:
providing the first content item as a recommended content item to each of a third plurality of user devices with a respective third voting control on a respective third content user interface;
receiving respective one or more third votes for the first content item from one or more of the third plurality of user devices through one or more of the respective third voting controls; and
calculating the first score for the first content item based on at least the first votes and the respective one or more third votes.

15. The computer-readable medium of claim 10, wherein the operations further comprise:
receiving a vote count request for the first content item from a third user device, the vote count request having been generated by a script that had been embedded in a respective third content user interface provided to the third user device; and
in response to the vote count request, providing a positive vote count and a negative vote count of the respective first votes.

16. The computer-readable medium of claim 15, wherein the third user device presents the positive vote count and the negative vote count for the first content item within or in proximity to the respective first voting control on the respective third content user interface shown on the third user device.

17. The computer-readable medium of claim 15, wherein the operations further comprise:
providing the first content item to each of a fourth plurality of user devices with a respective fourth voting control on a respective fourth content user interface; and
receiving respective one or more fourth votes for the first content item from one or more of the fourth plurality of user devices,
wherein the positive vote count and the negative vote count for the first content item are based on at least the respective first votes and the respective one or more fourth votes for the first content item.

18. The computer-readable medium of claim 10, wherein the operations further comprise:
ranking a plurality of content items for which respective votes have been received from user devices, the plurality of content items including at least the first content item and the second content item, and the ranking being based on at least on respective scores calculated from the respective votes received for the plurality of content items;
receiving a content request from a third user device, the content request having been generated by a respective script embedded in a respective third content user interface shown on the third user device; and
in response to the content request, providing a plurality of referral elements for presentation on the third content user interface, each referral unit referring to a respective one of the plurality of content items whose rank is above a predetermined rank threshold.

19. A system, comprising:
one or more processors; and
memory having instructions stored thereon, the instructions, when executed by one or more processors, cause the processors to perform operations comprising:
receiving, at a server, from a first plurality of user devices respective first votes for a first content item, the first content item being hosted by a first content source and provided to each of the first plurality of user devices with a respective first voting control on a respective first content user interface;
receiving, at the server, from a second plurality of user devices respective second votes for a second content item, the second content item being hosted by a second content source distinct from the first content source, and provided to each of the second plurality of user devices with a respective second voting control on a respective second content user interface, wherein each of the first voting controls and the second voting controls is configured to transmit a respective vote received on a respective user device to the server;
calculating a first score for the first content item based at least in part on the first votes, and a second score for the second content item based at least in part on the second votes; and
ranking the first content item hosted by the first content source and the second content item hosted by the second, distinct content source, based at least in part on the first score of the first content item and the second score of the second content item.

20. The system of claim 19, wherein the first votes include at least a positive vote and at least a negative vote for the first content item, and wherein the first score is based on a first statistical confidence interval of the first votes and the second score is based on a second statistical confidence interval of the second votes.

21. The system of claim 19, wherein the first content source and the second content source are two distinct websites, and the first content user interface and the second user interface are respective one or more webpages of the two distinct websites, respectively.

22. The system of claim 19, wherein data for generating the first content user interface is provided to each of the first plurality of client devices with an accompanying script, and the accompanying script is configured to generate the respective first voting control when executed on the client device.

23. The system of claim 19, wherein the operations further comprise:
providing the first content item as a recommended content item to each of a third plurality of user devices with a respective third voting control on a respective third content user interface;
receiving respective one or more third votes for the first content item from one or more of the third plurality of user devices through one or more of the respective third voting controls; and
calculating the first score for the first content item based on at least the first votes and the respective one or more third votes.

24. The system of claim 19, wherein the operations further comprise:
receiving a vote count request for the first content item from a third user device, the vote count request having been generated by a script that had been embedded in a respective third content user interface provided to the third user device; and
in response to the vote count request, providing a positive vote count and a negative vote count of the respective first votes.

25. The system of claim 24, wherein the third user device presents the positive vote count and the negative vote count for the first content item within or in proximity to the respective first voting control on the respective third content user interface shown on the third user device.

26. The system of claim 24, wherein the operations further comprise:
providing the first content item to each of a fourth plurality of user devices with a respective fourth voting control on a respective fourth content user interface; and
receiving respective one or more fourth votes for the first content item from one or more of the fourth plurality of user devices,
wherein the positive vote count and the negative vote count for the first content item are based on at least the respective first votes and the respective one or more fourth votes for the first content item.

27. The system of claim 19, wherein the operations further comprise:
ranking a plurality of content items for which respective votes have been received from user devices, the plurality of content items including at least the first content item and the second content item, and the ranking being based on at least on respective scores calculated from the respective votes received for the plurality of content items;
receiving a content request from a third user device, the content request having been generated by a respective script embedded in a respective third content user interface shown on the third user device; and
in response to the content request, providing a plurality of referral elements for presentation on the third content user interface, each referral unit referring to a respective one of the plurality of content items whose rank is above a predetermined rank threshold.
